(19) United States
(12) Patent Application Publication
(10) Pub. No.: US 2023/0177161 A1
(43) Pub. Date: Jun. 8, 2023

(54) BIOS CHANGE REQUESTS SIGNINGS BASED ON PASSWORDS

(71) Applicant: HEWLETT-PACKARD DEVELOPMENT COMPANY, L.P., SPRING, TX (US)

(72) Inventors: Valiuddin Ali, Spring, TX (US); Richard Bramley, Mansfield, MA (US); Joshua Serratalli Schiffman, Bristol (GB)

(21) Appl. No.: 17/545,145

(22) Filed: Dec. 8, 2021

(51) Int. Cl. G06F 21/57; G06F 21/60; G06F 21/64

(52) U.S. Cl. CPC G06F 21/572; G06F 21/575; G06F 21/602; G06F 21/64

(57) ABSTRACT

An example non-transitory computer readable storage medium comprising instructions that when executed cause a processor of an electronic device to: receive a password during a runtime of an operating system of the electronic device; generate a cryptographic key using the password; sign a Basic Input/Output System (BIOS) change request using the cryptographic key; and transmit the signed BIOS change request.

### BACKGROUND

An electronic device, such as a laptop computer, a tablet computer, a smart phone, etc. may include a Basic Input/Output System (BIOS) that controls different settings of the electronic device. BIOS setting management is of vital security importance to an organization. That is because the BIOS setting includes many security critical settings that can provide protection against malicious attacks.

### BRIEF DESCRIPTION OF THE DRAWINGS

Some examples of the present application are described with respect to the following figures:

FIG. 1A illustrates a system that uses a signed BIOS change request generated based on a password, according to an example;

FIG. 1B illustrates a system that uses a signed BIOS change request generated based on a password, according to another example;

FIG. 2 illustrates an electronic device that generates a signed BIOS change request based on a password, according to an example;

FIG. 3 illustrates an electronic device that generates a signed BIOS change request based on a password, according to another example;

FIG. 4 illustrates an electronic device that generates a signed BIOS change request based on a password, according to another example;

FIG. 5 illustrates an electronic device that generates a signed BIOS change request based on a password, according to another example; and

FIG. 6 illustrates an electronic device that generates a signed BIOS change request based on a password, according to another example.

### DETAILED DESCRIPTION

Control of BIOS settings in even the most modern devices such as personal computers (e.g., laptop computers, desktop computers) have been controlled through the use of password-based schemes. While modern techniques using cryptography are starting to become more common, there is still a major gap in availability, and features vary from device to device which means that some devices may have these newer capabilities while the existing/older devices do not. Practical and monetarily feasible approaches may discourage customers from adopting two separate schemes and policies to manage disparate devices so many times, they tend to gravitate to using the least commonly available denominator security technology to manage all devices, in this case which means use of passwords. Examples described herein provide a bridged solution to manage BIOS settings. The solution enables customers to use password-based schemes while taking advantages of the security properties offered by cryptographic schemes.

In an example, a non-transitory computer readable storage medium comprising instructions that when executed cause a processor of an electronic device to: receive a password during a runtime of an operating system of the electronic device; generate a private key using the password; sign a Basic Input/Output System (BIOS) change request using the private key; and transmit the signed BIOS change request to a target device.

In another example, a non-transitory computer readable storage medium comprising instructions that when executed cause a processor of an electronic device to: generate a basis input/output system (BIOS) change request from an application executing on the electronic device; generate a second private key using a password, wherein a first private key is stored in electronic device, and wherein the first private key is inaccessible to the application; sign the BIOS change request using the second private key; and transmit the signed BIOS change request from the application to a BIOS of the electronic device.

In another example, a non-transitory computer readable storage medium comprising instructions that when executed cause a processor of an electronic device to: receive a first password at a Basic Input/Output System (BIOS) of the electronic device; generate a first cryptographic key using the first password at the BIOS; receive a second password during a runtime of an operating system (OS) of the electronic device; generate a second cryptographic key using the second the password; sign a BIOS change request using the second cryptographic key at the operating system; transmit the signed BIOS change request from the OS to the BIOS; and verify the signed BIOS change request at the BIOS using the first cryptographic key.

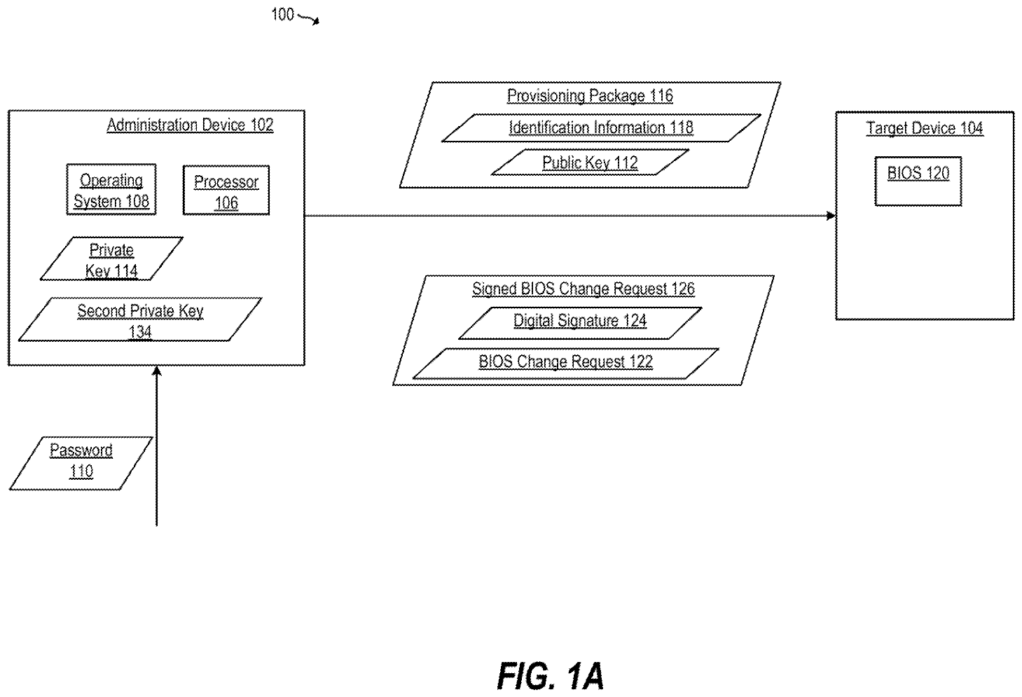

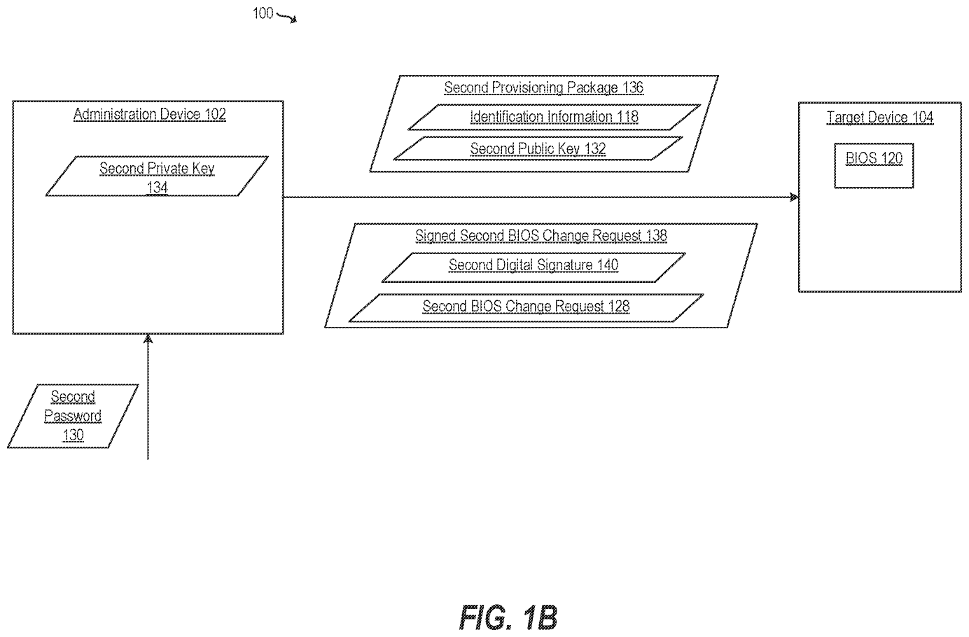

Turning to FIG. 1A, FIG. 1 illustrates a system 100 that uses a signed BIOS change request generated based on a password, according to an example. System 100 includes an administration device 102 and a target device 104. Administration device 102 may be, for example, a notebook computer, a desktop computer, an all-in-one system, a tablet computing device, a mobile phone, an electronic book reader, a wearable computing device, or any electronic device that is suitable to generate a signed BIOS change request based on a password. Target device 104 may be, for example, a notebook computer, a desktop computer, an all-in-one system, a tablet computing device, a mobile phone, an electronic book reader, a wearable computing device, or any electronic device that is suitable to configure a BIOS of target device 104 based on a signed BIOS change request.

Administration device 102 includes a processor 106 and an operating system 108. Processor 106 controls operations of administration device 102. Operating system 108 is a set of processor executable instructions that act as an interface between hardware components of administration device 102 and a user of administration device 102. During an operation to change a BIOS setting in target device 104, administration device 102 receives a password 110 during a runtime of operating system 108. As used herein, runtime of operating system 108 means a period of time during which operating system 108 is executing on administration device 102.

As an example of receiving password 110 at administration device 102, administration device 102 generates and displays a graphical user interface in a display device (not shown in FIG. 1) connected to administration device 102. A user of administration device 102 enters password 110 via the graphical user interface. Password 110 can be a word, a phrase, a string of characters, a set of numbers, or any information or data suitable to be used to generate a set of cryptographic keys.

In response to receiving password 110, administration device 102 generates a set of cryptographic keys (e.g., an asymmetric key pair) using password 110. The set of cryptographic keys includes a public key 112 and a private key 114. As used herein, public key 112 is a cryptographic key that is shared between administration device 102 and target device 104 and private key 114 is a cryptographic key that is not shared between administration device 102 and target device 104. Different key derivation functions may be used to convert password 110 to public key 112 and private key 114, such as Password-Based Key Derivation Function 1 (PBKDF1), Password-Based Key Derivation Function 2 (PBKDF2), Argon2, Ballon Hashing, etc.

Administration device 102 stores private key 114 locally in administration device 102. As an example, administration device 102 stores private key 114 in a hardware security module connected to administration device 102. A hardware security module (HSM) may be any tamper-resistant storage device. In another example, administration device 102 stores private key 114 in a secure database that is located in a remote server. It should be understood that other secure storage mechanisms may also be used to store private key 114.

Administration device 102 generates a provisioning package 116 that enables target device 104 to verify a BIOS change request transmitted by administration device 102. Provisioning package 116 includes public key 112 and identification information 118 of target device 104. Identification information 118 may be any information that distinctly identifies target device 104, such as a Media Access Control (MAC) address of target device 104, an Internet protocol (IP) address assigned to target device 104, a globally unique identifier (GUID) assigned to target device 104, etc.

Once provisioning package 116 is generated, administration device 102 transmits provisioning package 116 to target device 104. In response to receiving provisioning package 116, target device 104 verifies that target device 104 is the intended recipient of provisioning package 116 by comparing identification information 118 with corresponding identification information in target device 104. When the verification is successful, target device 104 extracts public key 112 via a BIOS 120 of target device 104. BIOS 120 stores public key 112 on target device 104. As an example, BIOS 120 stores public key 112 in a HSM (not shown in FIG. 1) connected to target device 104. BIOS 120 also sets a flag in BIOS 120 that indicates that any subsequent BIOS change request to change a setting of BIOS 120 is to be verified using a cryptographic scheme (e.g., a signature-based scheme).

Subsequent to provisioning target device 104 with public key 112, administration device 102 generates a BIOS change request 122. BIOS change request 122 is an instruction to change a setting in BIOS 120. In an example, BIOS change request 122 includes a name of a BIOS setting and a value associated with the BIOS setting. In another example, BIOS change request 122 includes the name of the BIOS setting, the value associated with the BIOS setting, an anti-replay counter, and identification information 118 of target device 104. An example BIOS setting is remote access configuration and an example value is enabled or disabled. Another example BIOS setting is password on boot and an example value is enabled or disabled.

Administration device 102 signs BIOS change request 122 using private key 114. For example, administration device 102 signs BIOS change request 122 by attaching a digital signature 124 to BIOS change request 122. Administration device 102 generates a hash using BIOS change request 122. For example, the content of BIOS change request 122 is fed through a hash function to generate the hash. Administration device 102 then encrypts the hash using private key 114 to generate digital signature 124. Administration device 102 appends or attaches digital signature 124 to BIOS change request 122 to generate a signed BIOS change request 126. Thus, signed BIOS change request 126 includes digital signature 124 and BIOS change request 122. Administration device 102 then transmits signed BIOS change request 126 to target device 104.

In response to receiving signed BIOS change request 126, target device 104 forwards signed BIOS change request 126 to BIOS 120. For example, an operating system of target device 104 (not shown) forwards signed BIOS change request 126 to BIOS 120 via a communication channel or interface such as Windows Management Instrumentation (WMI). BIOS 120 verifies signed BIOS change request 126 using public key 112 extracted from provisioning package 116. For example, BIOS 120 generates a first hash by feeding BISO change request 122 into a hashing function. BIOS 120 decrypts digital signature 124 using public key 112 to generate a second hash. When the first hash matches the second hash matches, the verification is successful. In response to a successful verification, BIOS 120 applies a setting change to BIOS 120 based on signed BIOS change request 126. That is, BIOS 120 applies the setting change to BIOS 120 according to BIOS change request 122.

In some examples, administration device 102 generates a unique set of cryptographic keys for each BIOS change request. Turning to FIG. 1B, for example, subsequent to transmitting signed BIOS change request 126 to target device 104, administration device 102 receives an instruction to generate a second BIOS change request 128 to change another setting of BIOS 120. Administration device 102 uses a second password 130 that is different than password 110 to generate a second public key 132 and a second private key 134. For example, administration device 102 receives second password 130 from a user of administration device 102. Because second password 130 is different from password 110, the resulting second public key 132 and second private key 134 are also different from public key 112 and private key 114, respectively. Administration device 102 provisions second public key 132 to target device 104 via a second provisioning package 136 that includes second public key 132 and identification information 118.

After generating second BIOS change request 128, administration device 102 generates a signed second BIOS change request 138 by signing second BIOS change request 128 using second private key 134. Signed second BIOS change request 138 includes second BIOS change request 128 and a second digital signature 140 that is generated using second private key 134. Administration device 102 then transmits signed second BIOS change request 138 to target device 104. Target device 104 is able to verify signed second BIOS change request 136 using second public key 132. In response to a successful verification, target device 104 applies a setting change to BIOS 120 according to second BIOS change request 128.

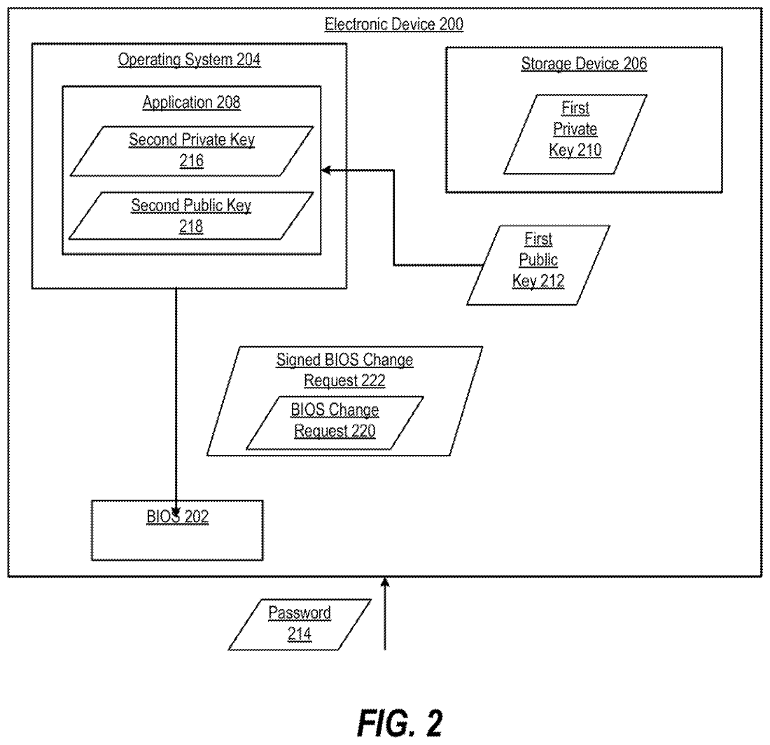

FIG. 2 illustrates an electronic device 200 that generates a signed BIOS change request based on a password, according to an example. Electronic device 200 may be, for example, a notebook computer, a desktop computer, an all-in-one system, a tablet computing device, a mobile phone, an electronic book reader, a wearable computing device, or any electronic device that is suitable to generate a signed BIOS change request based on a password. Electronic device 200 includes a BIOS 202, an operating system 204, and a storage device 206. Electronic device 200 may implement administration device 102 of FIG. 1 and/or target device 104 of FIG. 1.

During operation, operating system 204 is executing on electronic device 200. An application 208 is also executing within operating system 204 on electronic device 200. A first private key 210 and a first public key 212 are stored in storage device 206. In an example, first private key 210 and first public key 212 are generated using a key generation function from a password as described in FIGS. 1A and 1B. In some examples, first private key 210 and first public key 212 are stored separately in different storage devices.

First private key 210 is inaccessible to application 208. That is, application 208 is not able to obtain or have access to first private key 210. Application 208 generates a BIOS change request 220 to change a setting in BIOS 202, however, application 208 is not able to sign BIOS change request 220 as application 208 is not able to access first private key 210 and first public key 212 is used to verify any BIOS change request signed using first private key 210.

Application 208 regenerates an identical cryptographic key pair as first private key 210 and first public key 212 by receiving a password 214 (e.g., from a user of electronic device 200). Password 214 is used to generated first private key 210 and first public key 212. Thus, application 208 is able to generate a second private key 216 and a second public key 218, where second private key 216 matches first private key 210 and second public key 218 matches first public key 212.

Application 208 signs BIOS change request 220 using second private key 216 to generate a signed BIOS change request 222. Application 208 transmits signed BIOS change request 222 to BIOS 202 via operating system 204. BIOS 202 verifies signed BIOS change request 222 using first public key 212 or second public key 218. In response to a successful verification, BIOS 202 applies a setting change to BIOS 202 according to second BIOS change request 128. In examples where BIOS change request 220 is intended for a BIOS in a remote device, application 208 transmits BIOS change request 220 to the remote device instead of BIOS 202.

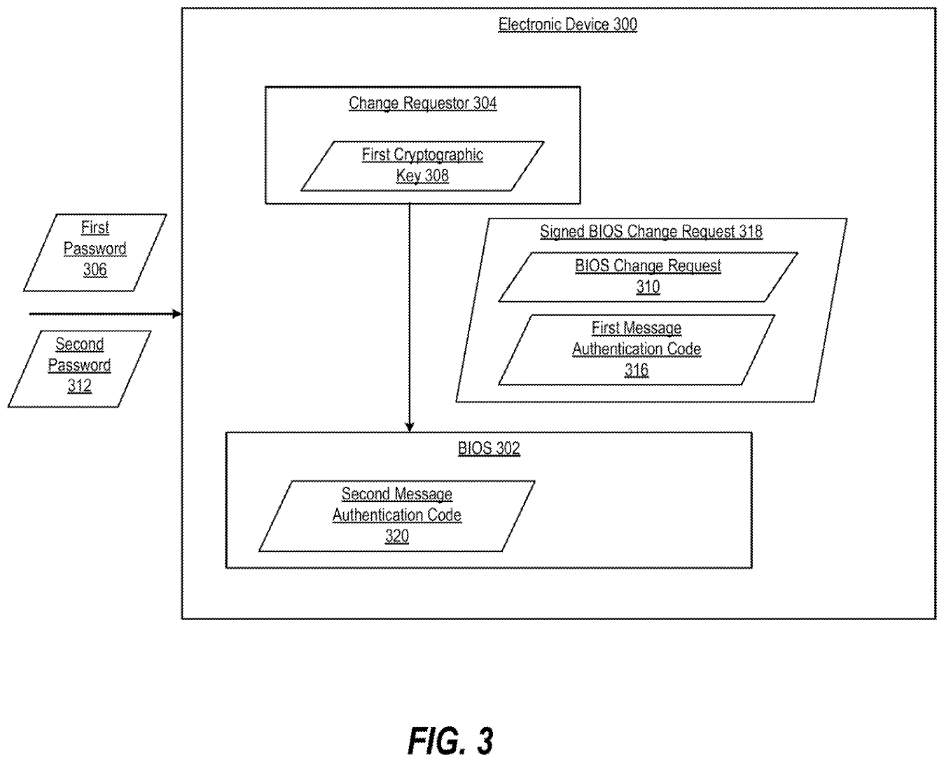

FIG. 3 illustrates an electronic device 300 that generates a signed BIOS change request based on a password, according to another example. Electronic device 300 may be similar to electronic device 200 of FIG. 2. In contrast to the asymmetric key example described in FIGS. 1A and 1B, electronic device 300 employs a symmetric key approach to verify a BIOS change request.

Electronic device 300 includes a BIOS 302 and a change requestor 304. Change requestor 304 may be any software (implemented using processor executable instructions) that generates a BIOS change request. For example, change requestor 304 is an operating system of electronic device 300. As another example, change requestor 304 is an application executing on electronic device 300.

During operation, electronic device 300 receives a first password 306. BIOS 302 transforms first password 306 into a first cryptographic key 308 via a key derivation function, such as PBKDF2. BIOS 302 then stores first cryptographic key 308 in a secure manner, such as storing in a HSM (not shown in FIG. 3) connected to electronic device 300. In some examples, first password 306 is a BIOS password. That is, first password 306 is a credential to access BIOS 302.

During a runtime of change requestor 304, change requestor 304 generates a BIOS change request 310. Change requestor 304 receives a second password 312. Second password 312 matches first password 306. Change requestor 304 generates a second cryptographic key 314 using second password 312. Second cryptographic key 314 matches first cryptographic key 308.

Change requestor 304 then signs BIOS change request 310 using second cryptographic key 314. For example, change requestor 304 computes a first message authentication code (MAC) 316 using second cryptographic key 314. First MAC 316 is a piece of information used to authenticate a message. First MAC 316 may be implemented as a Hash-based MAC (HMAC) by using a hash function, such as a SHA-2 or SHA-3. Change requestor 304 appends or attaches first MAC 316 to BIOS change request 310 to form a signed BIOS change request 318.

Change requestor 304 transmits signed BIOS change request 318 to BIOS 302. In response to receiving signed BIOS change request 318, BIOS 302 retrieves first cryptographic key 308 and computes a second MAC 320 using first cryptographic key 308. BIOS 302 compares second MAC 320 to first MAC 316 to verify signed BIOS change request 318. When BIOS 302 determines that second MAC 320 matches first MAC 316, the verification is successful. In response to the successful verification, BIOS 302 applies a setting change to BIOS 302 based on signed BIOS change request 318.

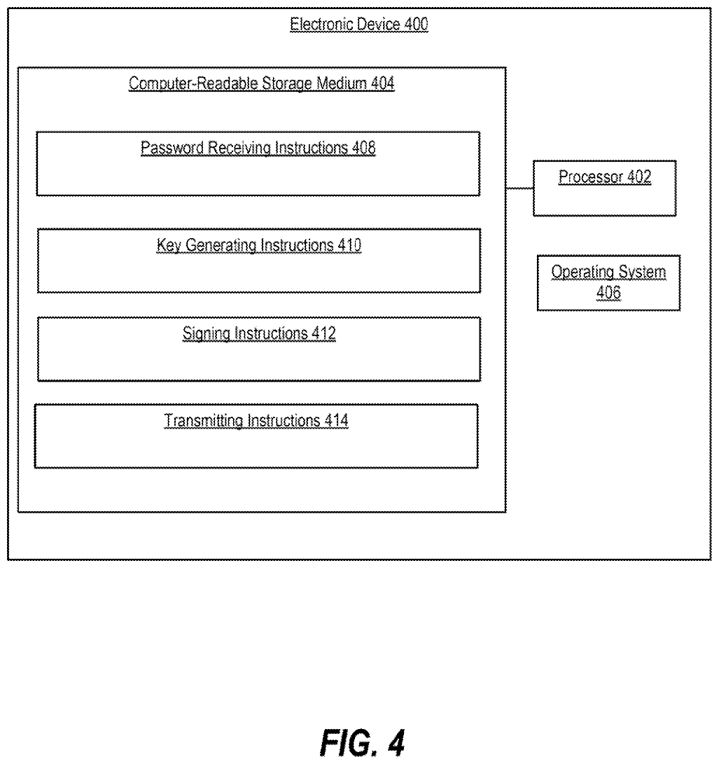

FIG. 4 illustrates an electronic device 400 that generates a signed BIOS change request based on a password, according to another example. Electronic device 400 includes a processor 402, a computer-readable storage medium 404, and an operating system 406. Electronic device 400 may implement administration device 102 of FIGS. 1A and 1B.

Processor 402 may be similar to processor 106. Processor 402 may be a central processing unit (CPU), a semiconductor-based microprocessor, an integrated circuit (e.g., a field-programmable gate array, an application-specific integrated circuit), a chipset, and/or other hardware devices suitable for retrieval and execution of instructions stored in a computer-readable storage medium. Processor 402 fetches, decodes, and executes instructions 408, 410, 412, and 414 to control operations of electronic device 400. Computer-readable storage medium 404 may be any electronic, magnetic, optical, or other physical storage device that contains or stores executable instructions. Thus, computer-readable storage medium 404 may be, for example, Random Access Memory (RAM), an Electrically Erasable Programmable Read-Only Memory (EEPROM), a storage device, an optical disc, etc. In some examples, computer-readable storage medium 404 may be a non-transitory storage medium, where the term “non-transitory” does not encompass transitory propagating signals. Computer-readable storage medium 404 is encoded with a series of processor executable instructions 408, 410, 412, and 414.

Password receiving instructions 408 receive a password during a runtime of operating system 406 of electronic device 400. For example, referring to FIG. 1A, a user of administration device 102 enters password 110 via the graphical user interface during a runtime of operating system 108 of administration device 102.

Key generating instructions 410 generate a cryptographic key using the password. For example, referring to FIG. 1A, in response to receiving password 110, administration device 102 generates a set of cryptographic keys (e.g., an asymmetric key pair) using password 110. The set of cryptographic keys includes a public key 112 and a private key 114.

Signing instructions 412 sign a BIOS change request using the cryptographic key. For example, referring to FIG. 1, administration device 102 signs BIOS change request 122 by attaching a digital signature 124 to BIOS change request 122. Transmitting instructions 414 transmit the signed BIOS change request to a target device. For example, referring to FIG. 1A, administration device 102 transmits signed BIOS change request 126 to target device 104.

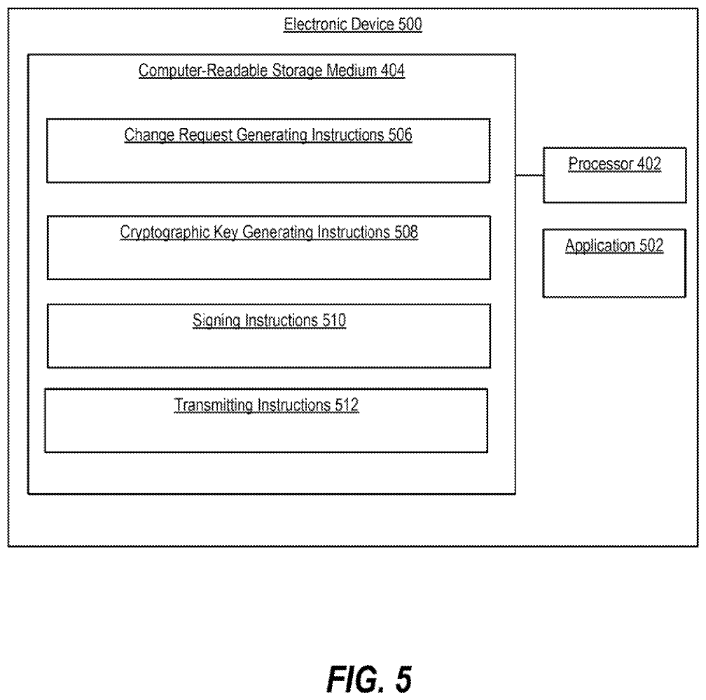

FIG. 5 illustrates an electronic device 500 that generates a signed BIOS change request based on a password, according to another example. Electronic device 500 may implement electronic device 200 of FIG. 2. Electronic device 500 includes processor 402, computer-readable storage medium 404, an application 502 implemented using processor executable instructions, and a BIOS 504. Computer-readable storage medium 404 is encoded with a series of processor executable instructions 506, 508, 510, and 512.

Change request generating instructions 506 generate a BIOS change request from application 502 executing on electronic device 500. For example, referring to FIG. 2, application 208 generates a BIOS change request 220 to change a setting in BIOS 202.

Cryptographic key generating instructions 508 generate a cryptographic key using a password. For example, referring to FIG. 2, application 208 regenerates an identical cryptographic key pair as first private key 210 and first public key 212 by receiving a password 214 (e.g., from a user of electronic device 200).

Signing instructions 510 sign the BIOS change request using the cryptographic key. For example, referring to FIG. 2, application 208 signs BIOS change request 220 using second private key 216 to generate a signed BIOS change request 222. Transmitting instructions 512 transmit the signed BIOS change request from application 502 to BIOS 504 of electronic device 500. For example, referring to FIG. 2, application 208 transmits signed BIOS change request 222 to BIOS 202 via operating system 204.

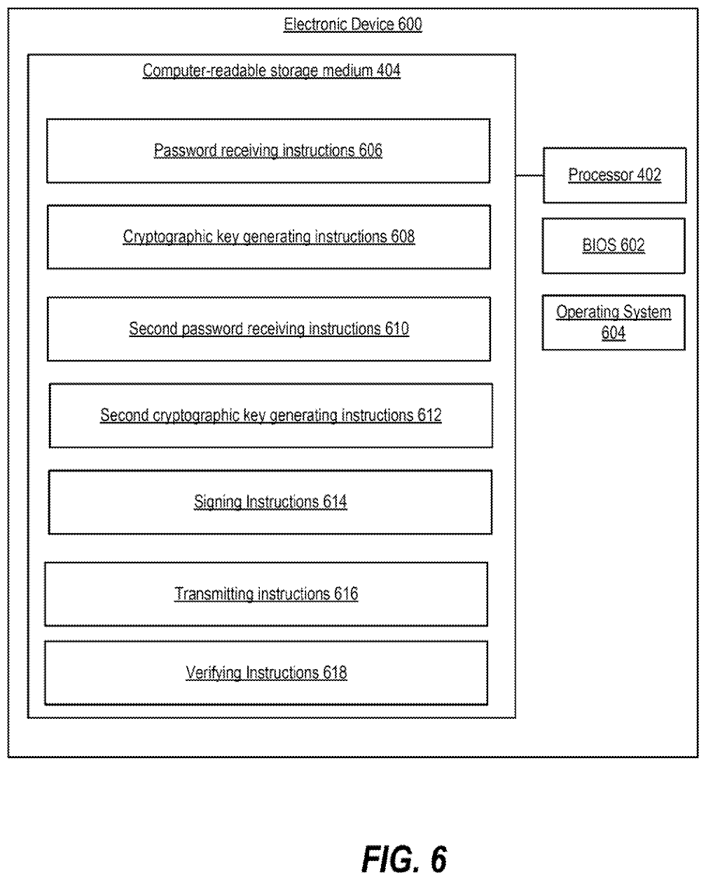

FIG. 6 illustrates an electronic device 600 that generates a signed BIOS change request based on a password, according to another example. Electronic device 600 may implement electronic device 300 of FIG. 3. Electronic device 600 includes processor 402, computer-readable storage medium 404, a BIOS 602, and operating system 604. Computer-readable storage medium 404 is encoded with a series of processor executable instructions 606, 608, 610, 612, 614, 616, and 618.

Password receiving instructions 606 receive a first password at BIOS 602 of electronic device 600. For example, referring to FIG. 3, electronic device 300 receives a first password 306. Cryptographic key generating instructions 608 generate a first cryptographic key using the first password at BIOS 602. For example, referring to FIG. 3, BIOS 302 transforms first password 306 into a first cryptographic key 308 via a key derivation function, such as PBKDF2.

Second password receiving instructions 610 receive a second password during a runtime of operating system 604. For example, referring to FIG. 3, change requestor 304 receives a second password 312. Second cryptographic key generating instructions 612 generate a second cryptographic key using the second password. For example, referring to FIG. 3, change requestor 304 generates a second cryptographic key 314 using second password 312.

Signing instruction 614 sign a BIOS change request using the second cryptographic key at the operating system. For example, referring to FIG. 3, change requestor 304 then signs BIOS change request 310 using second cryptographic key 314. Transmitting instructions 616 transmit the signed BIOS change request from the operating system to the BIOS. For example, referring to FIG. 3, change requestor 304 transmits signed BIOS change request 318 to BIOS 302. Verifying instructions 618 verify the signed BIOS change request at the BIOS using the first cryptographic key. For example, referring to FIG. 3, in response to receiving signed BIOS change request 318, BIOS 302 retrieves first cryptographic key 308 and computes a second MAC 320 using first cryptographic key 308. BIOS 302 compares second MAC 320 to first MAC 316 to verify signed BIOS change request 318.

Each of electronic devices 400, 500, and 600 may be, for example, a notebook computer, a desktop computer, an all-in-one system, a tablet computing device, a mobile phone, an electronic book reader, a wearable computing device, or any electronic device that is suitable to generate a signed BIOS change request based on a password.

As used herein, a basic input/output system (BIOS), such as BIOS 120 of FIGS. 1A and 1B, BIOS 202 of FIG. 2, and BIOS 302 of FIG. 3, refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

The use of “comprising”, “including” or “having” are synonymous and variations thereof herein are meant to be inclusive or open-ended and do not exclude additional unrecited elements or method steps.

What is claimed is:

1. A non-transitory computer readable storage medium comprising instructions that when executed cause a processor of an electronic device to:
receive a password during a runtime of an operating system of the electronic device;
generate a private key using the password;
sign a Basic Input/Output System (BIOS) change request using the private key; and
transmit the signed BIOS change request o a target device.

2. The non-transitory computer readable storage medium of claim 1, wherein the instructions when executed further cause the processor to:
generate a public key using the password; and
transmit the public key to the target device in a provisioning package.

3. The non-transitory computer readable storage medium of claim 2, wherein the provisioning package includes identification information of the target device.

4. The non-transitory computer readable storage medium of claim 2, wherein the instructions when executed further cause the processor to store the public key at a storage device of the electronic device.

5. The non-transitory computer readable storage medium of claim 1, wherein the BIOS change request includes a name of a BIOS setting, a value associated with the BIOS setting, an anti-replay counter, and identification information of the target device.

6. The non-transitory computer readable storage medium of claim 1, wherein the BIOS is implemented using Unified Extensible Firmware Interface (UEFI).

7. The non-transitory computer readable storage medium of claim 1, wherein the instructions when executed further cause the processor to:
receive a second password during the runtime, wherein the second password is different from the password;
generate a second private key using the second password;
sign a second BIOS change request using the second private key; and
transmit the signed second BIOS change request to the target device.

8. A non-transitory computer readable storage medium comprising instructions that when executed cause a processor of an electronic device to:
generate a Basis Input/Output System (BIOS) change request from an application executing on the electronic device;
generate a second private key using a password, wherein a first private key is stored in electronic device, and wherein the first private key is inaccessible to the application;
sign the BIOS change request using the second private key; and
transmit the signed BIOS change request from the application to a BIOS of the electronic device.

9. The non-transitory computer readable storage medium of claim 8, wherein the instructions when executed further cause the processor to:
verify, in BIOS, the signed BIOS change request using a public key, wherein the public key is associated with the first private key and the second private key; and
in response to a successful verification of the signed BIOS change request, apply a setting change to the BIOS based on the signed BIOS change request.

10. The non-transitory computer readable storage medium of claim 8, wherein the first private key matches the second private key.

11. The non-transitory computer readable storage medium of claim 8, wherein the instructions when executed further cause the processor to:
in response to receiving a provisioning package from an administration device, extract a public key associated with the first private key from the provisioning package; and
set a flag to indicate that a BIOS change request is to be verified using a cryptographic scheme.

12. The non-transitory computer readable storage medium of claim 11, wherein the provisioning package includes identification information of the administration device.

13. The non-transitory computer readable storage medium of claim 8, wherein the BIOS is implemented using Unified Extensible Firmware Interface (UEFI).

14. The non-transitory computer readable storage medium of claim wherein the first private key is inaccessible to the application.

15. A non-transitory computer readable storage medium comprising instructions that when executed cause a processor of an electronic device to:
receive a first password at a Basic Input/Output System (BIOS) of the electronic device;
generate a first cryptographic key using the first password at the BIOS;
receive a second password during a runtime of an operating system (OS) of the electronic device;
generate a second cryptographic key using the second password;
sign a BIOS change request using the second cryptographic key at the operating system;
transmit the signed BIOS change request from the OS to the BIOS; and
verify the signed BIOS change request at the BIOS using the first cryptographic key.

16. The non-transitory computer readable storage medium of claim 15, wherein the instructions when executed further cause the processor to:
in response to a successful verification, apply a setting change to the BIOS based on the signed BIOS change request.

17. The non-transitory computer readable storage medium of claim 15, wherein the BIOS is implemented using Unified Extensible Firmware Interface (UEFI).

18. The non-transitory computer readable storage medium of claim 15, wherein the the second password matches the first password.

19. The non-transitory computer readable storage medium of claim 15, wherein the first cryptographic key matches the second cryptographic key.

20. The non-transitory computer readable storage medium of claim 15, wherein the first password is a credential to access the BIOS.
